(19) United States
(12) Patent Application Publication
(10) Pub. No.: US 2012/0132155 A1
(43) Pub. Date: May 31, 2012

(54) CYLINDER HEAD HAVING PLURAL WATER JACKETS AND CAST-IN WATER RAIL

(75) Inventors: Matthew Giles SMITH, Darlington (GB); Stephen SAXBY, Beijing (CN); Jerl PURCELL, Louisa, VA (US); John ANDERSON, Thirsk (GB)

(73) Assignee: CUMMINS INTELLECUTAL PROPERTIES, INC., Minneapolis, MN (US)

(21) Appl. No.: 13/168,859

(22) Filed: Jun. 24, 2011

Related U.S. Application Data
(60) Provisional application No. 61/358,594, filed on Jun. 25, 2010.

(51) Int. Cl. F02F 1/40; F02F 1/14

(52) U.S. Cl. 123/41.79

(57) ABSTRACT

This disclosure provides a cylinder head having a structure allowing for more uniform lateral coolant flow, and an internal combustion engine including such a cylinder head. The cylinder head includes a lower water jacket cavity, an upper water jacket cavity in fluid communication with the lower water jacket cavity through plural orifices formed in cylinder head material between the lower and upper jacket cavities, and a coolant outlet passage extending from the upper water jacket cavity to a lateral side of the cylinder head. A rail cavity is provided in the cylinder head, extends in a longitudinal direction of the cylinder head, and is in fluid communication with the coolant outlet passage. A lateral passage is provided in the cylinder head upstream from the coolant outlet passage with a portion of the rail cavity therebetween. The lateral passage fluidly connects the upper water jacket cavity to the rail cavity to allow lateral flow of coolant in areas of the cylinder head upstream from the coolant outlet passage.

### CROSS REFERENCE TO RELATED APPLICATIONS

This application claims benefit of priority to Provisional Patent Application No. 61/358,594, filed on Jun. 25, 2010, the entire contents of which are hereby incorporated by reference.

### FIELD OF THE INVENTION

The invention relates to the structure of a cylinder head including a water jacket for use with an internal combustion engine, and more particularly, to a cylinder head including plural water jackets with a cast-in water rail.

### BACKGROUND

A cylinder head of an internal combustion engine can include a number of cavities through which liquid coolant (e.g., water) flows to provide vital cooling to the intake and exhaust ports, valve guide features, valve seats, and combustion deck of the cylinder head. FIG. 1 is a simplified diagram of a conventional cylinder head 100 for an internal combustion engine having a liquid coolant system. The liquid coolant system includes a lower water jacket 102a separated from an upper water jacket 102b by material 103 of the cylinder head 100 (e.g., cast iron or aluminum). The cylinder head material 103 also defines other peripheral confines of the lower/upper water jackets 102a/102b. The lower water jacket 102a includes inlet orifices 112a to 112d that are in fluid communication with engine block water jackets of an internal combustion engine (not shown). The cylinder head passages include the water jackets 102a/102b to allow heat transfer from the cylinder head material 103 and other cylinder head components to liquid coolant flowing through the cylinder head 100.

### SUMMARY

The present disclosure provides a cylinder head having plural water jackets and a rail cavity, and an internal combustion engine including such a cylinder head, which can provide for more uniform cooling of the cylinder head material and cylinder head components.

In one embodiment of the disclosure, a cylinder head for an internal combustion engine includes a lower water jacket cavity formed in material of the cylinder head, an upper water jacket cavity formed in the cylinder head material and in fluid communication with the lower water jacket cavity through plural orifices formed in cylinder head material between the lower and upper jacket cavities, and a coolant outlet passage extending from the upper water jacket cavity to a lateral side of the cylinder head. The cylinder head includes a rail cavity provided in the cylinder head material that is spaced from the upper water jacket cavity. The rail cavity extends in a longitudinal direction of the cylinder head and is in fluid communication with the coolant outlet passage. A lateral passage is provided in the cylinder head material upstream from the coolant outlet passage with a portion of the rail cavity between the lateral passage and the coolant outlet passage. The lateral passage fluidly connects the upper water jacket cavity to the rail cavity.

In another embodiment of the disclosure, an internal combustion engine includes an engine block having plural cylinders and water jacket passages, and a cylinder head sealing the cylinders and including upper and lower water jackets and a rail cavity. The upper water jacket cavity is in fluid communication with the lower water jacket cavity through plural orifices formed in the cylinder head between the upper and lower water jackets, and a coolant outlet passage extends from the upper water jacket cavity to a lateral side of the cylinder head. The rail cavity in the cylinder head is spaced from the upper water jacket cavity, extends in a longitudinal direction of the cylinder head, and is in fluid communication with the coolant outlet passage. At least one lateral passage is provided in the cylinder head upstream from the coolant outlet passage with a portion of the rail cavity between the lateral passage and the coolant outlet. The lateral passage fluidly connects the upper water jacket cavity with the rail cavity. The water jacket passages in the engine block fluidly communicate with the lower water jacket cavity and constitute a portion of a fluid cooling circuit for the internal combustion engine.

### BRIEF DESCRIPTION OF THE DRAWINGS

FIG. 1 is a diagram of a conventional cylinder head including a coolant passage system.

FIG. 2 is a diagram of a cylinder head and coolant passage system in accordance with an exemplary embodiment.

FIG. 3 is a diagram of a water jacket core system according to an exemplary embodiment, which can be used to form passages in a cylinder head of an internal combustion engine.

FIG. 4 is a diagram of a cylinder head having a coolant passage system including two water jackets and an integrated rail structure in accordance with an exemplary embodiment.

### DETAILED DESCRIPTION

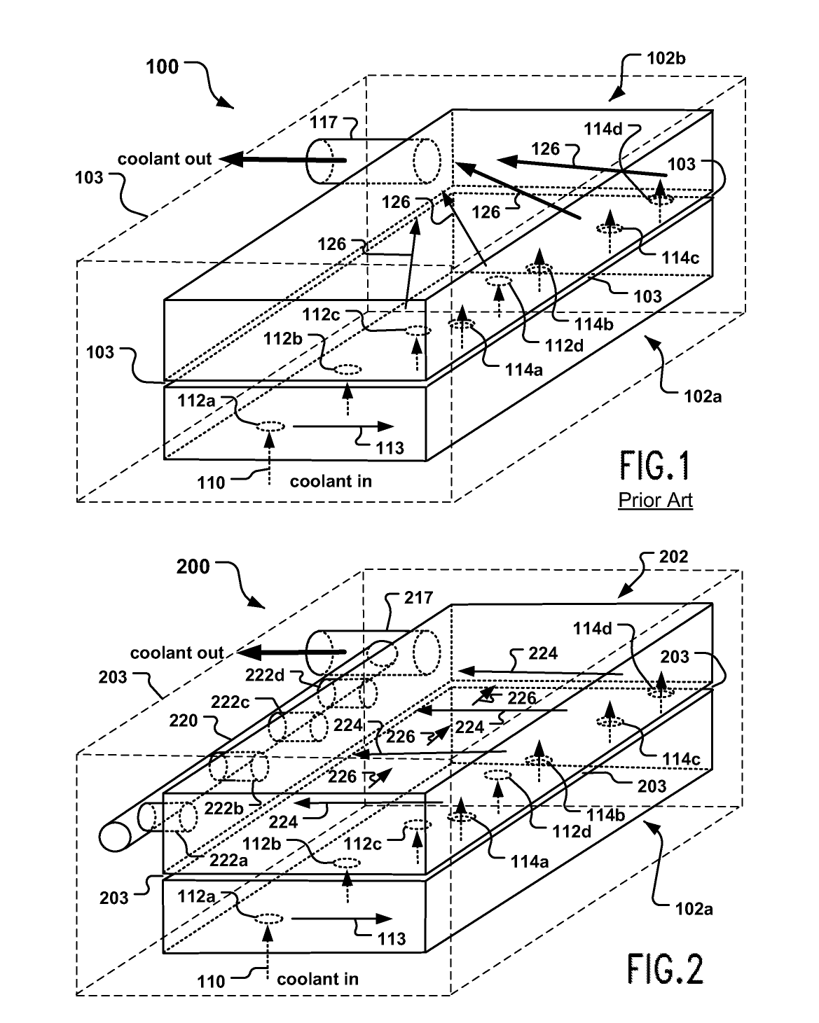

With respect to conventional cylinder head designs, the inventors realized that when coolant flows in an upper water jacket towards the coolant outlet of the cylinder head, a majority of the coolant entering the upper water jacket tends to flow in a longitudinal direction of the cylinder head. For example, in the cylinder head shown in FIG. 1, coolant 110 supplied by a water pump (not shown) flows from the engine block water jackets (not shown), enters the lower water jacket 102a through the orifices 112a to 112d, and thereafter generally flows across the water jacket 102a along paths in the direction shown by arrow 113 (i.e., left-to-right in the orientation depicted in FIG. 1) toward orifices 114a to 114d, which fluidly communicate with the upper water jacket 102b. The coolant 110 then passes through each of the orifices 114a to 114d and enters the upper water jacket 102b. However, after entering the upper water jacket 102b, a majority of the coolant 110 flowing from the orifices 114a to 114d tends to flow in a longitudinal direction of the cylinder head (i.e., a direction from the rear to the front of the engine) towards the coolant outlet passage 117, as illustrated by plural arrows 126. As a result, flow of coolant 110 across the cylinder head 100 in a direction transverse to the longitudinal direction of the head is non-uniform or practically nonexistent in some areas of the upper water jacket 102b.

Non-uniform, longitudinally directed coolant flow such as described above can cause a temperature differential across portions of the cylinder head 100, which can stress the cylinder head material 103 over a number of operating cycles to a point where the cylinder head 100 cracks and/or distorts. Additionally, engine efficiency, durability, and/or reliability can be adversely affected when one or more of the cylinder head components, such as intake ports, exhaust ports, valve seats are not properly cooled.

Exemplary embodiments of the present disclosure that address the above-noted shortcomings will now be described with reference to the drawings, in which elements having the same reference numbers as those discussed previously herein are described above. Starting with FIG. 2, a simplified diagram of a cylinder head 200 according to an exemplary embodiment of the disclosure is shown. The cylinder head 200 includes a coolant passage system having a plural water jacket design integrated with a rail cavity structure. As shown in FIG. 2, the coolant passage system 200 includes an upper water jacket 202 and a lower water jacket 102a that form cavities in cylinder head material 203 through which liquid coolant 110 can flow. The upper water jacket 202 fluidly communicates with a lower water jacket 102a via orifices 114a to 114d formed through the cylinder head material 203. The upper water jacket 202 also fluidly communicates with a rail cavity 220 that extends along a substantial portion of the length of the cylinder head in the longitudinal direction.

In this exemplary embodiment shown in FIG. 1, the rail cavity is laterally separated from the upper water jacket 202 by cylinder head material 203, but fluidly communicates with the upper water jacket 202 via plural laterally oriented passages 222a to 222d formed in the cylinder head material 203. It is to be appreciated that a fewer or greater number of passages may fluidly couple the upper water jacket 202 to the rail cavity 220, for example, to accommodate a corresponding greater or less number of engine cylinders. A downstream end of the rail cavity 220 fluidly communicates with a coolant outlet 217 and an upstream end of rail cavity terminates near the lateral passage 222a, although the rail cavity may terminate at the last lateral passage in line from the coolant outlet 217. The rail cavity 220 extends at from a coolant outlet passage 217 of the cylinder head 200 to a point along a longitudinal side of the water jacket 202 opposite to, or near opposite to the orifice 114a.

The rail cavity 220 allows control of the flow of coolant 110 that results in an increased amount of laterally directed coolant flow throughout the volume of the water jacket 202 of the cylinder head 200, as shown by arrows 224, relative to the amount of coolant flow in the longitudinal direction, as shown by arrows 226. Additionally, the rail cavity 220 makes lateral coolant flow more uniform along the longitudinal length of the cylinder head 200. The flow of coolant 110 can therefore be managed through critical areas of the head (between the lower and upper jackets) by balancing the pressure in the upper jacket using the rail feature. By allowing the coolant 110 to be directed in a more controlled manner, pressure loss through the cylinder head and coolant system can be reduced.

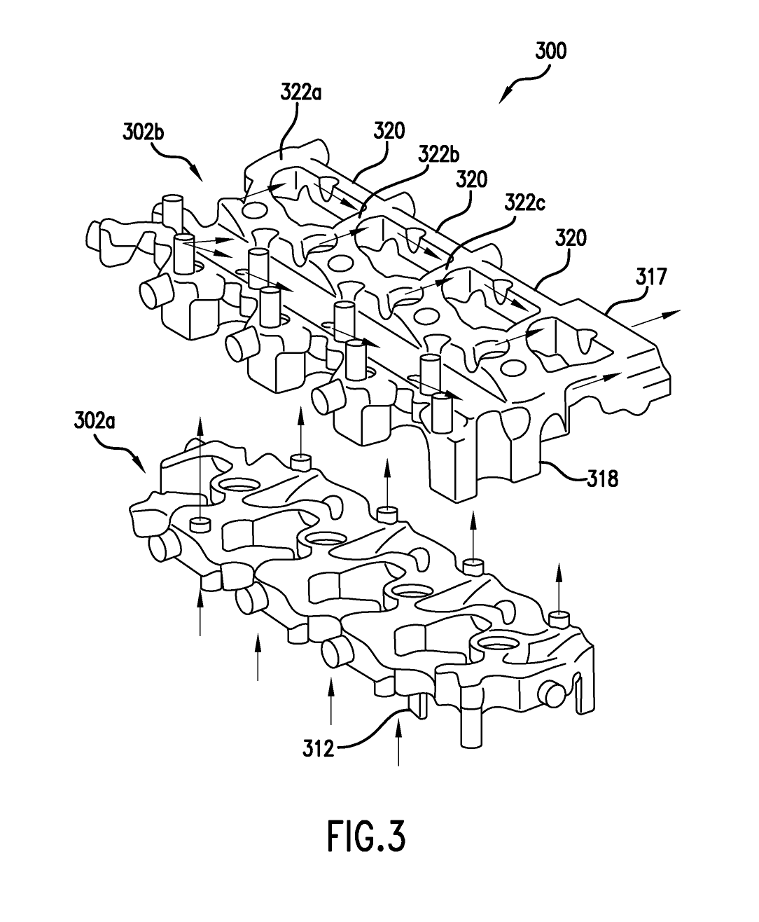

FIG. 3 shows an exemplary embodiment of a water jacket core system 300 that can be used to form a cylinder head of an internal combustion engine. The core system includes a lower core section 302a for forming the lower water jacket cavity and an upper core section 302b for forming an integrated upper water jacket cavity and rail cavity within cylinder head material (not shown). The upper core portion 302b includes an upper water jacket cavity core portion 318, a rail cavity core portion 320, and plural coolant passage core portions 322a to 322c that form fluid passages in the cylinder head between with the upper jacket cavity and the rail cavity. An end portion of the upper core portion 302b includes a coolant outlet passage core portion 317 to form a coolant outlet passage for a cylinder head and includes two leg core portions that form passages to fluidly couple the upper water jacket core portion 318 to the outlet passage core portion 317.

As shown in FIG. 3, the upper core section 302b can be formed integrally with the passage core portions 322a to 322c and rail portion 320, although upper core section 302b can include two or more separate core portions that can be assembled together to form the upper core section 302b and attached, e.g., glued together, assembled using an assembly screw or some other kind of fastener, and or clamped or otherwise held into position within a molding box before molding (casting) the cylinder head.

The lower core section 302a is provided with plural extensions 312 that reach the surface of the cylinder head that includes the combustion chambers (not shown), which when mated with the surface of the engine block to seal a bank of cylinders, provides a coolant passage from the engine block to the lower water jacket. Additionally, although not shown in FIG. 3, orifices are formed between an upper water jacket formed by the upper core section 302b and a lower water jacket formed by lower core section 302a allow for fluid communication of coolant between the upper/lower water jackets of a cylinder head.

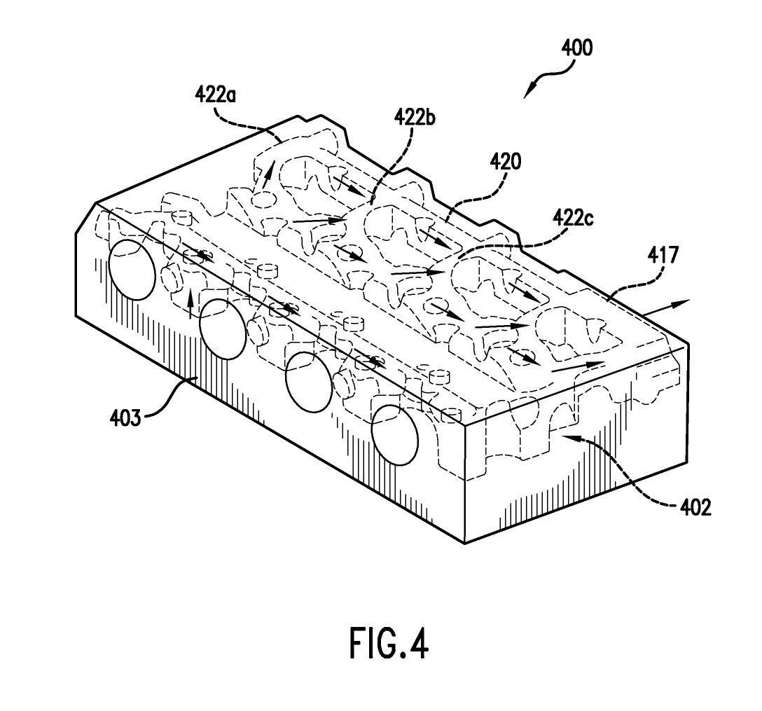

FIG. 4 is a diagram of an exemplary embodiment of a cylinder head 400 having a coolant passage system that includes a two-piece water jacket design integrated with a rail structure. For clarity of illustration, only the upper water jacket 402 is shown phantom view in a simplified block shape of cylinder head material 403. Also shown in phantom is a rail cavity 420 connected to a coolant outlet portion 417 and to the upper water jacket 402 via passages 422a to 422c. The arrows illustrate the increased lateral component of coolant flow in areas of the upper water jacket distant from the coolant outlet 417, such as areas where the passageways 422a to 422c connect with the upper water jacket 402.

Cylinder head embodiments utilizing plural water jacket and rail designs described herein can reduce pressure loss through the cylinder head, and thus allow for a reduced size water pump, improved power and reduced fuel consumption. Such a cylinder head would be more evenly cooled, which would add robustness and improve the life of the cylinder head and other engine components, and allow for designing cylinder heads closer to the design margins.

Although a limited number of embodiments is described herein, one of ordinary skill in the art will readily recognize that there could be variations to any of these embodiments and those variations would be within the scope of the disclosure. Thus, it will be apparent to those skilled in the art that various changes and modifications can be made to the cylinder head described herein without departing from the scope of the appended claims and their equivalents.

What is claimed is:

1. A cylinder head for an internal combustion engine, comprising:
a lower water jacket cavity formed in material of the cylinder head;
an upper water jacket cavity formed in the cylinder head material and in fluid communication with the lower water jacket cavity through plural orifices formed in cylinder head material between the lower and upper jacket cavities;
a coolant outlet passage extending from the upper water jacket cavity to a lateral side of the cylinder head;
a rail cavity in the cylinder head material spaced from the upper water jacket cavity, said rail cavity extending in a longitudinal direction of the cylinder head and in fluid communication with the coolant outlet passage; and
a lateral passage in the cylinder head material upstream from the coolant outlet passage with a portion of the rail cavity therebetween, said lateral passage fluidly connecting the upper water jacket cavity to the rail cavity.

2. The cylinder head according to claim 1, wherein the rail cavity is connected to the coolant outlet passage, and the combined longitudinal length of the rail cavity and the coolant outlet passage extends along substantially the entire longitudinal length of the cylinder head.

3. The cylinder head according to claim 1, further comprising:
plural lateral passages in the cylinder head material upstream from the coolant outlet passage with a portion of the rail cavity between each adjacent pair of the plural lateral passages, wherein
each of said plural lateral passages fluidly connects the upper water jacket cavity with the rail cavity.

4. The cylinder head according to claim 1, wherein longitudinal lengths of the upper and lower water jacket cavities are approximately the same.

5. The cylinder head according to claim 1, wherein the upper and lower water jacket cavities extend along substantially the entire longitudinal length of the cylinder head.

6. The cylinder head according to claim 2, wherein the upper and lower water jacket cavities extend along substantially the entire longitudinal length of the cylinder head.

7. An internal combustion engine, comprising:
an engine block including plural cylinders and water jacket passages;
a cylinder head sealing the cylinders, said cylinder head including:
a lower water jacket cavity;
an upper water jacket cavity in fluid communication with the lower water jacket cavity through plural orifices formed in the cylinder head between the upper and lower water jackets;
a coolant outlet passage extending from the upper water jacket cavity to a lateral side of the cylinder head;
a rail cavity in the cylinder head spaced from the upper water jacket cavity, said rail cavity extending in a longitudinal direction of the cylinder head and in fluid communication with the coolant outlet passage; and
at least one lateral passage in the cylinder head upstream from the coolant outlet passage with a portion of the rail cavity between the lateral passage and the coolant outlet, said lateral passage fluidly connecting the upper water jacket cavity to the rail cavity, wherein
the water jacket passages in the engine block fluidly communicate with the lower water jacket cavity and constitute a portion of a fluid cooling circuit for the internal combustion engine.

8. The internal combustion engine according to claim 7, wherein the rail cavity is connected to the coolant outlet passage, and the combined longitudinal length of the rail cavity and the coolant outlet passage extends along substantially the entire longitudinal length of the cylinder head.

9. The internal combustion engine according to claim 7, further comprising:
plural lateral passages in the cylinder head upstream from the coolant outlet passage with a portion of the rail cavity between each adjacent pair of the plural lateral passages, wherein
each of said plural lateral passages fluidly connects the upper water jacket cavity with the rail cavity.

10. The internal combustion engine according to claim 7, wherein longitudinal lengths of the upper and lower water jacket cavities are approximately the same.

11. The internal combustion engine according to claim 7, wherein the upper and lower water jacket cavities extend along substantially the entire longitudinal length of the cylinder head.

12. The internal combustion engine according to claim 8, wherein the upper and lower water jacket cavities extend along substantially the entire longitudinal length of the cylinder head.
